(19) United States
(12) Patent Application Publication
(10) Pub. No.: US 2019/0156444 A1
(43) Pub. Date: May 23, 2019

(54) SYSTEMS, DEVICES, AND METHODS FOR CONTROLLING ACCESS TO REAL PROPERTY AND OTHER ASSET INFORMATION

(71) Applicants: Israel Murrey Targownik, New York, NY (US); Sandra Balan, New York, NY (US)

(72) Inventors: Israel Murrey Targownik, New York, NY (US); Sandra Balan, New York, NY (US)

(21) Appl. No.: 16/198,478

(22) Filed: Nov. 21, 2018

Related U.S. Application Data
(60) Provisional application No. 62/588,955, filed on Nov. 21, 2017.

(51) Int. Cl. G06Q 50/16; G06Q 50/18

(52) U.S. Cl. CPC G06Q 50/163; G06Q 50/188

(57) ABSTRACT

Systems, devices, and methods for an a remote lock having a processor with addressable memory, the remote lock in communication with a remote access component; a first buyer device having a processor with addressable memory, the first buyer device in communication with the remote access component; where the remote access component is configured to send a code to the remote lock and the first buyer device; where the first buyer device is configured to transmit the code; where the remote lock is configured to receive the code transmitted by the first buyer device; and where the remote lock is configured to unlock a door if the received code transmitted by the first buyer device matches the code received by the remote access component.

### CROSS-REFERENCE TO RELATED APPLICATIONS

This application claims priority to and the benefit of U.S. Provisional Patent Application No. 62/588,955, filed Nov. 21, 2017, the contents of which are hereby incorporated by reference herein for all purposes.

### TECHNICAL FIELD

Embodiments relate generally to real property, and more particularly to the access, sale, and leasing of real property.

### BACKGROUND

Existing property search systems require sellers to list each of their properties. A middleman, or broker, is used to allow for viewings of the real property by a buyer and negotiations between the buyer and seller. The use of the middleman increases costs for both sellers and buyers. In addition, the public availability of information relating to the property may provide unintended consequences. Further, the current search engines limit searches to properties currently on the market and not properties coming to the market at a future date in time.

### SUMMARY

A system embodiment may include: a server computing device, a buyer computing device, and a seller computing device, each comprising a processor and addressable memory and in electronic communication with each other. In one embodiment, the server computing device may be configured to register one or more buyer computing devices and associate each buyer computing device with a buyer profile; register one or more seller computing devices and associate each seller computing device with a seller profile; determine search results of one or more registered buyer computing devices matching one or more buyer criteria via a seller search component; transmit a message from the registered seller computing device to a registered buyer computing device from the determined search results; provide access to the registered buyer computing device of a property from the one or more properties of the registered seller via a remote access component based on the transmitted message and the associated buyer computing device; and track movement of the registered buyer computing device in the accessed property via a viewer tracking component.

The system may further include a remote lock having a processor and addressable memory, the remote lock in communication with a remote access component of the server computing device and the registered buyer computing device in communication with the remote access component where the remote access component may be configured to send a code to the remote lock and the registered buyer computing device.

In some embodiments the first buyer computing device may be configured to transmit the code. In some embodiments the remote lock may be configured to receive the code transmitted by the registered buyer device. In other embodiments the remote lock may be configured to unlock a door if the received code transmitted by the registered buyer computing device matches the code received by the remote access component. In alternative embodiments the tracking movement may be via signals transmitted from the registered buyer computing device to the server computing device.

Additionally, the server computing device may be configured to facilitate an agreement between the registered buyer and the registered seller for the property of the registered seller via a negotiation component. In one embodiment the seller computing device may be configured to determine whether grant access to the buyer computing device based on information received from the server computing device, the information including location of the buyer computing device.

A method embodiment may include the steps of: registering one or more buyers and associated buyer computing device with a server computing device, where each buyer registration comprises buyer information and buyer criteria; registering one or more sellers and associated seller computing device with the server computing device, where each seller registration comprises seller information and one or more properties; determining, by the server computing device, search results of one or more registered buyers matching one or more buyer criteria via a seller search component; transmitting a message from a registered seller computing device to a registered buyer computing device from the determined search results; providing access to the registered buyer of a property from the one or more properties of the registered seller via a remote access component based on the transmitted message and the associated buyer computing device; tracking movement of the registered buyer in the accessed property via a viewer tracking component, where the tracking movement may be via signals transmitted from the registered buyer computing device to the server computing device; and facilitating an agreement between the registered buyer and the registered seller for the property of the registered seller via a negotiation component.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 depicts a high-level block diagram of a real property and asset information control system, according to one embodiment;

FIG. 2 depicts a high-level block diagram of a remote access system, according to one embodiment;

FIG. 3 depicts a real property equipped with a remote access system, according to one embodiment;

FIG. 4A depicts a high-level flowchart of a method embodiment of completing a transfer or sale of real property by a buyer;

FIG. 4B depicts a high-level flowchart of a method embodiment of completing a transfer or sale of real property by a seller;

FIG. 5 depicts a high-level flowchart of a method embodiment of providing access to real property;

FIG. 6 depicts a search performed in the real property and asset information control system, according to one embodiment;

FIG. 7 depicts an alternate search performed in the real property and asset information control system, according to one embodiment;

FIG. 8 illustrates an example top-level functional block diagram of a computing device embodiment;

FIG. 9 shows a high-level block diagram and process of a computing system for implementing an embodiment of the system and process;

FIG. 10 shows a block diagram and process of an exemplary system in which an embodiment may be implemented; and

FIG. 11 depicts a cloud computing environment for implementing an embodiment of the system and process disclosed herein.

### DETAILED DESCRIPTION

The present system allows for a seller to list their properties, search for buyers having criteria that match one or more of their properties, and show their properties to potential buyers. The seller can then contact buyers to answer any questions, arrange a viewing of the property, and negotiate a price for the property. In one embodiment, the buyer cannot contact the seller without the seller initiating contact through the system. This system allows both parties to avoid an intermediary, such as a real estate broker, and communicate in complete confidentiality. This system also allows a seller to connect with a buyer seeking to make a transaction at any timeframe, i.e., in the present or in the future. While buyers and sellers are discussed, these terms may include landlords, managers, etc. and purchasers, tenants, etc., respectively. Sales may include the sale or leasing of real property.

The disclosed system and method improves the real estate purchasing and/or leasing experience, by allowing sellers to locate and screen buyers for transactions that can occur either in the present or at any future date and/or timeframe. As compared to current real estate applications, the linearity of the process is reversed. Rather than providing buyers with a means of searching for suitable properties, the disclosed system and method provides sellers with a way to search for qualified buyers. By allowing sellers to search for buyers to make transactions at any future date and/or timeframe, both sellers and buyers benefit by expanding options and allowing both parties to have a great deal more control over the course of a transaction. The disclosed system and method may allow for the completion of a deal without a real estate broker and in complete confidentiality.

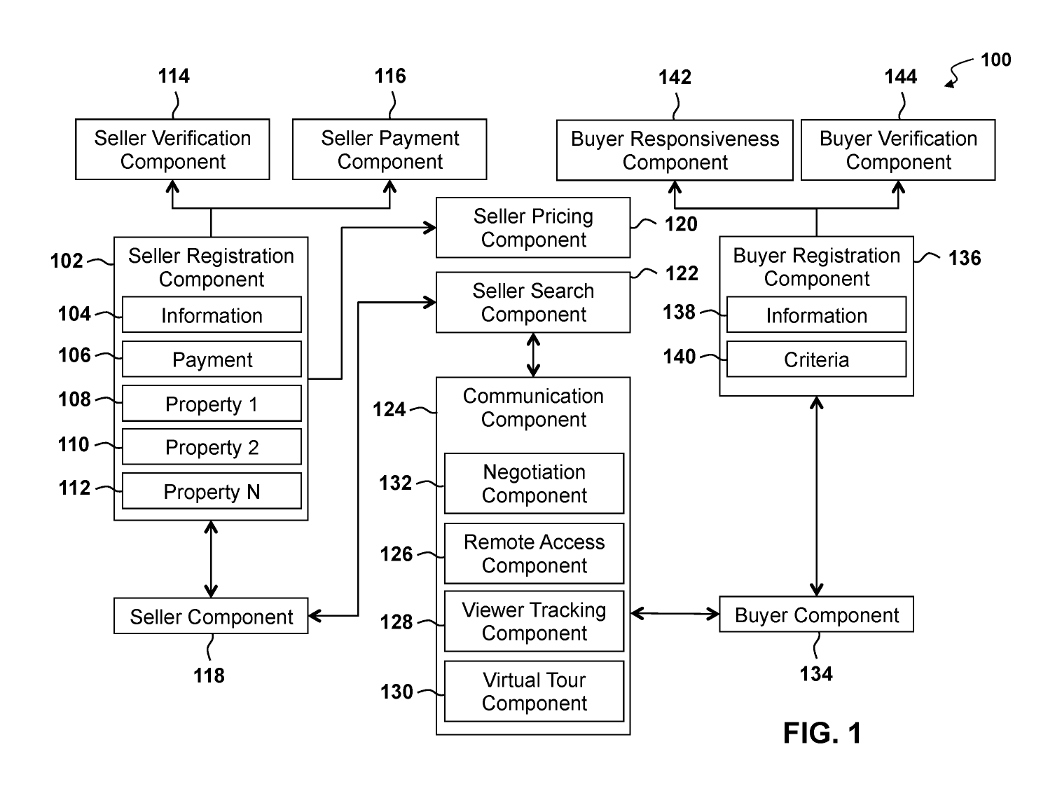

FIG. 1 depicts a high-level block diagram of a real property and asset information control system 100, according to one embodiment. The system 100 includes a seller registration component 102. The seller registration component 102 allows a seller to register for the system. A seller may include a real property owner, landlord, manager, authorized officer, etc. The seller provides and the system records seller information 104, payment information 106, and information on one or more seller properties 108, 110, 112.

A seller verification component 114 may provide verification of seller information 104 and/or information on the one or more seller properties 108, 110, 112. For example, the seller verification component 114 may perform a background check on the seller, a title check on information about the one or more seller properties 108, 110, 112, etc.

A seller payment component 116 may be used to process seller payments for access to the system 100. For example, each seller may pay a monthly or annual rate for each account, seller property 108, 110, 112, etc. The seller may maintain access to the system 100 as long as payment is received.

A seller component 118 may be used to provide access to the system 100. The seller component 118 may include a user interface to allow the seller to update their seller information 104, update their seller payment 106, update information on any of their properties (108, 110, 112), perform a search, and the like. The seller component 118 may be a downloadable application, such as an application on a smartphone, tablet, or portable computer.

The seller may use a seller pricing component 120 to receive information on pricing based on the information provided for each property 108, 110, 112. The seller pricing component 120 may provide estimated, or suggested, prices for a property based on information about that property, sales history, pricing trends, and the like. Based on the address for a property that the seller inputs into the system, the system 100 may determine the price range for the property and show the seller the latest market trends based on public records, pricing trends, sales data, and the like.

The seller may use a seller search component 122 to perform a search for one or more buyers that meet one or more criteria set by the seller in the seller component 118. The system allows sellers of real property to perform searches for buyers via the seller search component 122. Buyers looking to purchase and/or rent a property, today or in the future, may input their criteria 140, i.e., the attributes they are looking for in a property. This buyer criteria 140 may include budget cap, number of bedrooms/bathrooms, location, desired closing date or range of dates, desired lease start date or range of dates, and the like. The buyer may enter this buyer criteria 140 via a straightforward, easy to complete questionnaire. This buyer criteria 140 information may be maintained in a buyer database. Sellers may perform searches of this buyer database via the seller search component 122 based on a set of search criteria that the sellers input when performing the search.

The sellers may perform as many searches as they like, modifying their input criteria in any way they wish. The sellers may also have the ability to save searches, schedule searches to run continuously, and the like. For example, if a buyer inputs his or her information into the buyer database, and if this information matches the search criteria of a seller's saved search, then that seller may be notified that their search has generated a new result.

Buyers may not have any ability to perform searches, view any seller information or property information, and receive any notifications regarding new sellers and/or new properties. Buyers may only have the ability to add their buyer criteria 140 and buyer information 138 into the buyer database. If a seller performs a search and then wishes to contact one or more of the buyers on the generated list as their results, the sellers may do so. In one embodiment, the seller may only initiate the communication between the seller and the buyer.

Once the seller identifies a buyer that meets certain criteria via the seller search component 122, the seller may initiate communication with the identified buyer via a communication component 124. A buyer may not communicate with a seller unless the seller initiates communication with the buyer via the communication component 124.

In one aspect of the present embodiments, the communication component 124 may include a remote access component 126. The remote access component 126 may allow the seller to provide access to one or more properties without needing to physically be at the property. Accordingly, security is provided by the system based on scheduled time and location of the buyer so that the seller may be more willing to show their property.

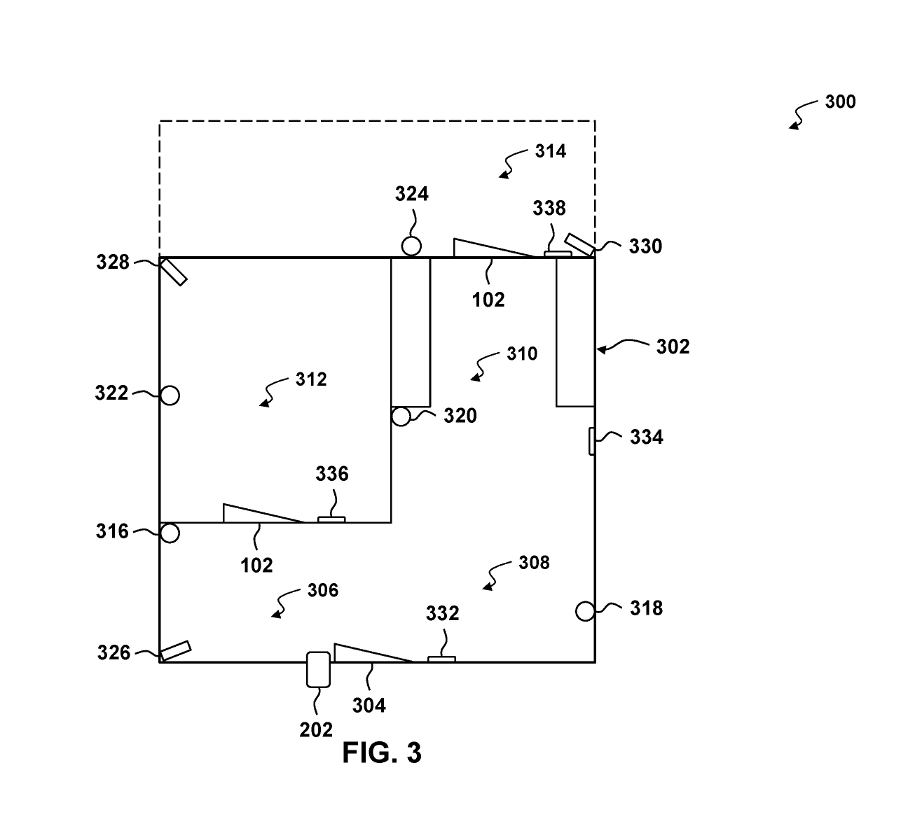

The viewer tracking component 128 may provide tracking of the buyer when at the property. The viewer tracking component 128 may provide information to the buyer depending on the room viewed, time of day, and the like. The viewer tracking component may use information from beacons, light switches, motion detectors, weather information, time of day, and the like as shown in FIG. 3. That is, the system may determine lighting, music, scent, or other remotely controlled IoT devices at the property based on the aforementioned conditions.

The virtual tour component 130 may allow the seller to provide a virtual tour to one or more buyers and answer any questions from the one or more buyers without the buyers needing to be physically present at the property. The seller and/or another individual can stream open houses while taking questions from prospective buyers. The buyer may be able to zoom in or out of the rooms of the property being shown.

The negotiation component 132 may be used to finalize a price, terms, and the like for a property between the buyer and seller. The negotiation component 132 may include contracts and agreements, allow for review by an attorney or real estate broker for the buyer and seller, allow for signature by the buyer and seller, and the like.

The buyer may communicate with the seller in the communication component 124 via the buyer component 134. The buyer component 134 may include a user interface to allow the buyer to update their buyer information 138, update their buyer criteria 140, respond to inquiries from the buyer responsiveness component 142, respond to inquiries from the buyer verification component 144, and the like. The buyer component 134 may be a downloadable application, such as an application on a smartphone, tablet, or portable computer.

The buyer registers for the system 100 via the buyer registration component 136. The buyer provides buyer information 138 and buyer criteria 140. The buyer criteria relate to what property the buyer is looking for. The buyer criteria 140 may be searched by sellers in the seller search component 122. The disclosed system allows sellers to run searches and receive automated alerts, e.g., via email, upon a successful match.

The system 100 may include a buyer responsiveness component 142. The buyer responsiveness component 142 may ensure that buyers are still using the system 100. The buyer responsiveness component 142 may query the buyer to perform an action to verify their responsiveness. If the buyer does not respond within a set time, the buyer's account in the system 100 may be locked or closed. For example, the buyer responsiveness component 142 may send a prompt to a buyer with a set time to respond. These prompts may be sent at regular intervals, e.g., once a week or once a month, or may be sent at random intervals. In one embodiment, failure to respond to a prompt may result in a warning, a time-out which blocks the buyer from using the site, or removal from the site. The buyer responsiveness component 142 may be used to ensure buyers are active on the system. Regular activity by a buyer on system, such as responding to messages from sellers, may preclude the need for scheduled or random prompts. That is, prompts may be based on a set of keep-alive messages sent from the buyer's device where each time a keep-alive message is received, the time intervals are reset.

After inputting the buyer information 138 and buyer criteria 140, a buyer's only obligation may be to respond to periodic emails or other communications confirming that the buyer is still actively seeking to purchase and/or rent a property. If no response is received from the buyer, the buyer's account may be deactivated and their buyer information 138 and buyer criteria 149 may be removed from the buyer database. The buyer responsiveness component 142 allows the buyer database to contain information that is both accurate and up-to-date. Buyers may also log into their account in order to modify their buyer information 138 and/or buyer criteria 140 if these should change.

The buyer verification component 144 may verify buyer information 138 provided by the buyer. The buyer verification component 144 may perform a background check, verify credit scores, verify rental history, and the like. In some embodiments, the buyer verification component 144 may be used as part of negotiations in the negotiation component 132, where output from the verification component 144 may be received as input by the negotiation component 132.

The disclosed system may eliminate broker fees, thereby resulting in higher profits for sellers and lower purchase prices for the buyer. For example, a seller may have the ability to offer their property for a lower sales or rental price than competing properties marketed by real estate agents since there are no commission fees. This will result in the seller realizing a higher net profit and the buyer realizing a saving. The system also will allow buyers to procure a property easier and avoid brokerage fees. Buyers can offer more for a rental property while not having to go over their annual budget to do so, as it will reduce a buyer's annual housing expenses. Due to being able to offer more for a property it will increase the buyer's chances of being selected by the seller. By not paying a commission the buyer can offer more for the property while still saving money vis a vis renting a similar property from a broker.

The disclosed system embodiments also gives sellers privacy and confidentiality in the sale or lease of property by not having to publically disclose information regarding their properties or conduct open houses. Sellers may control who can view their property since the seller will send the property to only those buyers the seller selects. The seller may also avoid unsolicited sales calls from real estate agents. Additionally, the present system may provide a seller currently available comparable properties as well as comparable properties that are in contract or have recently sold when the seller is to log-on to the system.

For example, a seller of a cooperative apartment may want to show their property only to buyers that are financially qualified to obtain board approval from the Board of Directors of the cooperative apartment. A seller who may be willing to accept a mortgage contingency clause or accept a guaranty will want to ensure the buyer and/or guarantor is financially qualified before granting access to the property. This allows the seller to obtain financial information, thereby ensuring only qualified buyers have access to the property and the belongings in the property, as well as ensure the seller's privacy.

Additionally, a seller that owns a property with attributes or defects, e.g., an electric stove, no views, no closets, or the like, that prevent most buyers from purchasing or leasing the property are able to disclose said matter prior to scheduling a showing or sharing information thereby saving the seller time and frustration. It also protects against unnecessary wear and tear on the property that comes with excessive viewings. The disclosed system replaces the current way that buyers learn of said problems, which is only after they have viewed the property, as most brokers do not publically post photographs of problematic areas of a property—in order not to deter others from coming to see the property. This ability to disclose information privately and in the most favorable light and before a viewing is scheduled will protect a troubled property from becoming stale and unsellable. The longer a property is marketed the less of a chance for the property to sell at a maximum value. Buyers just entering the market are less likely to visit a property that has been on the market for a while because the property will be perceived as one that must have an issue since it has been on the market for so long. By giving sellers the power to contact buyers directly, sellers can notify buyers of the issue without publically damaging the property. This will also allow a seller to learn what the market would be willing to pay for the property in an as-is condition.

By allowing sellers to search for buyers based on a budgeted amount the seller is able to contact only those individuals that are offering an amount deemed acceptable by the seller, which will avoid needless negotiations with others. A seller who does not want to deal with a buyer will not have to. A seller can choose only those individuals to give access to and/or information about the property, thereby protecting the confidentiality and privacy of the seller and property.

The disclosed system allows for principal-to-principal negotiations. For example, sellers can screen potential buyers without relying on someone else, especially if that someone else has a financial incentive to consummate the deal. There will be no third party to alter the parties' wishes. Screening may be done from a distance and before any property information is disclosed.

The principals, after speaking, may negotiate outcomes that could not have been achievable today. For instance, a seller may be open to holding a mortgage note for the buyer or willing to perform some work or give the buyer a credit towards work only after speaking to and feeling comfortable with the buyer. The seller may be able to negotiate other forms of payment/exchange that could substitute for part, or the entire purchase price or rental amount.

The system allows sellers the opportunity to notify buyers about properties prior to the property coming onto the market. For example, a buyer may be made aware of properties before the property is publically listed by the seller simply by signing up for the system. Sellers will contact buyers directly thereby resulting in the buyer not having to search for new property listings.

The system will also increase the number of potential buyers a seller has available and also increase the number of potential properties for buyers. For instance, buyers that have preselected a designated area to move to may not be familiar with similar neighborhoods and can be encouraged by the seller to view a property in another area after the parties have spoken. For instance, a buyer that may have checked off Beekman as their desired location may be interested in viewing a similar property a seller has in Sutton since the two areas are comparable areas. The disclosed system allows sellers the chance to speak to those buyers in order to try to explain these nuances.

The system allows sellers and/or buyers that are relocating to be matched with buyers and/or sellers who are also relocating. This ensures a smooth transition for both parties. For example, a seller and/or buyer that is relocating or a seller that has a buyer with an expiring lease or a buyer with an expiring lease looking to move would benefit from the disclosed system. A buyer usually has to visit properties in the location they are moving right before or after moving to secure a property. Buyers are limited to available properties and may have to purchase or rent a property that does not meet all of their needs. Rather than having to visit the location and view only available properties at the time of the move a buyer may input their desired property type, location and possession date months in advance of their move. The information will be maintained in the system's database. Sellers considering a relocation and sale or lease of their property can access the database to locate a buyer months in advance of the move. Also, a seller with a tenant that has an expiring lease will be able to locate a future buyer months in advance of the current tenant's departure. This will avoid the lost rental income that comes with the seller having to locate a new tenant.

The disclosed system embodiments are configured to provide features where both the seller and the buyer security, comfort, and confidence to move forward with their relocation plans months in advance of their move. Sellers and buyers may enter into a contract and buyers and sellers may enter into leases with closing/start dates that extend into the future, which will give both parties legal rights and obligations that secure the transaction for both parties. The disclosed system makes for an easier transition for both parties. The buyer can locate the ideal property, at the best price and both parties can make all necessary plans knowing they have a future place to reside.

The disclosed system grants sellers access to buyers in the database, notwithstanding the buyer input criteria. This allows sellers to have access to a greater pool of buyers thereby increasing the odds of maximizing a property's value. For example, a seller having a Battery Park City property can use the disclosed system to find a buyer and in doing so comes across a buyer seeking a property that almost exactly matches the seller's property except one input criteria. The buyer may select the Upper West Side as a buyer criteria 140. The reason the buyer chose the Upper West Side was that the buyer wants to live by a green space. Armed with this information, the seller can contact that buyer to notify them that Battery Park City also has a green space, in case buyer did not know, and to see if the buyer is interested in viewing their property.

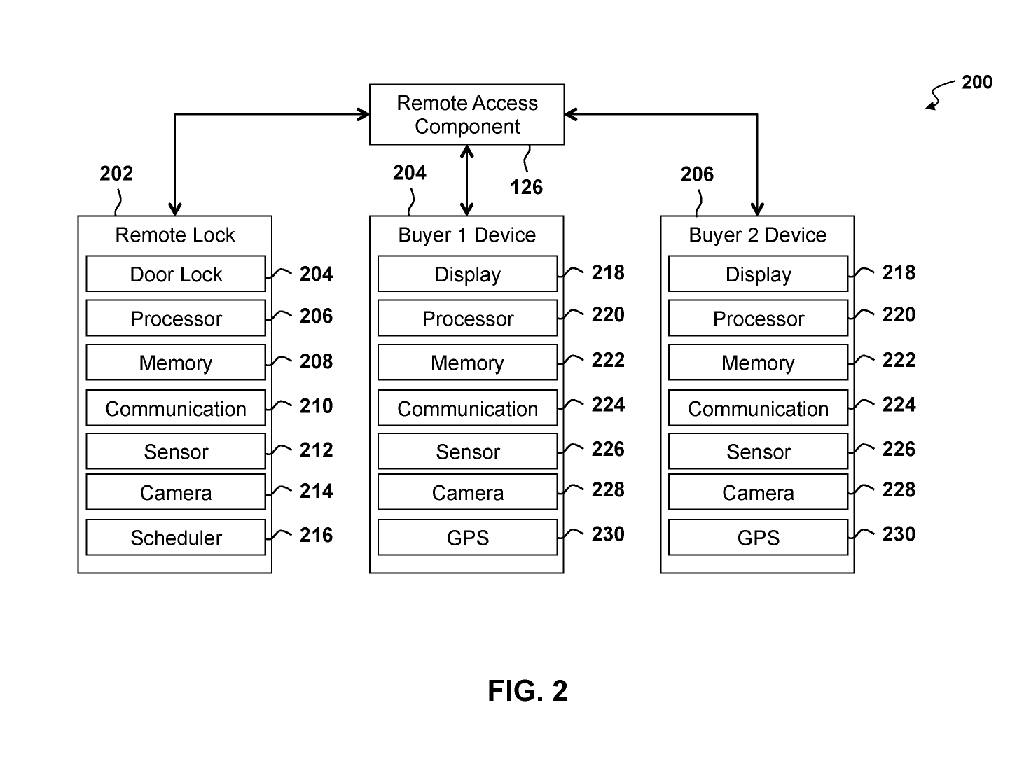

FIG. 2 depicts a high-level block diagram of a remote access system 200, according to one embodiment of the disclosed system. The remote access component 126 may be in communication with a remote lock 202 and one or more buyer devices 204, 206. The remote lock 202 may be a connected door lock for a property. The buyer devices 204, 206 may be a computing device such as a smartphone, tablet, portable computer, or the like.

The remote lock 202 may include a door lock 204, a processor 206 having addressable memory 208, communication 210, one or more sensors 212, a camera 214, and a scheduler 216. The remote lock 202 may communicate 210 with the remote access component 126 to determine whether to allow a buyer to visit a property. Communication 210 may be via cellular, wireless, Bluetooth, RFID, or the like.

In one embodiment, the buyer computing device or buyer device 204 may include a user interface display 218, a processor 220 having addressable memory 222, communication module 224, one or more sensors 226, a camera 228, and a GPS 230.

In one embodiment, the remote access component 126 may provide for a viewing time of a property by a buyer. The buyer device 204 may receive a QR code that may be displayed on a display 218 of the buyer device 204. The buyer may present the QR code to a camera 214 of the remote lock 202. The remote lock 202 may verify the QR code and unlock the door lock 204 to allow the buyer access the view the property.

In one embodiment where the remote access component 126 may provide for viewing of a property by multiple buyers, the location of each buyer, e.g., via GPS 230 in each respective buyer device 204, 206, may determine whether to allow access to the buyer via the remote lock 202. For example, if a first buyer arrives late to their scheduled view time, but the second buyer is still thirty minutes away from the property, then the remote lock 202 may provide access to the property. If the second buyer is five minutes away from the property, then the remote lock 202 may deny access to the property to avoid a scheduling conflict when the second buyer arrives to view the property. In one embodiment, should the second buyer get in close proximity of the property (where the distance may be predetermined by the seller as to what constitutes close proximity), via the GPS tracking, the first buyer may be alerted that their time in the property is up and they should exit the premises. Additionally, the second buy may not be granted access to the property if the first buyer is detected to still be inside, via GPS or other means. This may be done via the use of the scheduler 216 which may schedule showings based on location and how far the buyers are from the property; that is, for example if the second buyer is an hour away, the first buyer can go in but if the second buyer is only 5 minutes away, then the first buyer won't be given entry.

In one embodiment, the system 200 may provide a temporary key. The remote lock may be an Internet of Things (IoT) enabled lock mechanism. The remote lock 202 may include a door lock 204 that is electronically accessible. The buyer, via the buyer device, may request an access code from any location with a preferred time to visit. The system 200 may generate a Timed QR Code, which is valid for a set period of time. The seller may share the QR code, such as via the remote access component 126. The remote lock 202 may include a QR sensor or camera 214 to scan the QR code and check with the remote access component 126 if this QR code is not expired or valid. Upon validating the QR code, the door may be unlocked via the door lock 204. In some embodiments, the system 200 may check if there are any other buyers in a location and maintain a no conflict/overlap schedule. If the door is not electronically accessible, the seller and/or the remote access component 126 may electronically provide the combination to a key safe holding a key located outside the property.

FIG. 3 depicts a real property 302 equipped with a remote access system 300, according to one embodiment. The property 302 may include a remote lock 202, such as a door lock proximate a door 304 of the property 302. A buyer may access the interior of the property 302 via the remote lock 202. The property 302 may contain one or more areas 306, 308, 310, 312, 314. For example, these areas may be a living area 306, a dining area 308, a kitchen 310, a bedroom 312, and an outside area 314.

One or more beacons 316, 318, 320, 322, 324 may be present in the one or more areas 306, 308, 310, 312, 314. These beacons 316, 318, 320, 322, 324 may be used to track the buyer, via the buyer device, as the buyer moves throughout each of the areas 306, 308, 310, 312, 314 of the property 302. These beacons 316, 318, 320, 322, 324 may provide the buyer context-based content. The context-based content may include AR based content as the buyer moves throughout the property 302. For example, the AC and the power consumption can be displayed based on yearly-accrued bills and other information. The system may also show augmented views of the interior. The buyer may use AR to see how things look when its night or when the curtains are down or up in the daytime. The room can also be displayed with furniture to show how the property 302 will look when furniture is added if the property 302 is not furnished. Additionally, paint colors may be modified to show different options to the buyer, etc.

One or more sensors 326, 328, 330 may also be used to track the buyer as the buyer moves through each of the areas 306, 308, 310, 312, 314 of the property 302. The sensors 326, 328, 330 may be motion sensors, cameras, or the like. The sensors 326, 328, 330 may also be used to ensure that the buyer does not destroy or steal from the property.

One or more tracked switches 332, 334, 336, 338 may also be used to track the buyer as the buyer moves through each of the areas 306, 308, 310, 312, 314 of the property 302. The tracked switches 332, 334, 336, 338 may be wall switches and may communicate with the system 300 and/or buyer device when they are turned on or off. For example, when a light is turned on in a bedroom 312 via the tracked switch 336, the system 300 may determine that the buyer is in the bedroom 312 in the property. When the light is turned off in the bedroom 312 via the tracked switch 336, the system 300 may determine that the buyer has left the bedroom 312 and is in the living area 306. In one embodiment, the system may modify different settings on the IoT connected devices based on the information stored in the buyer's profile.

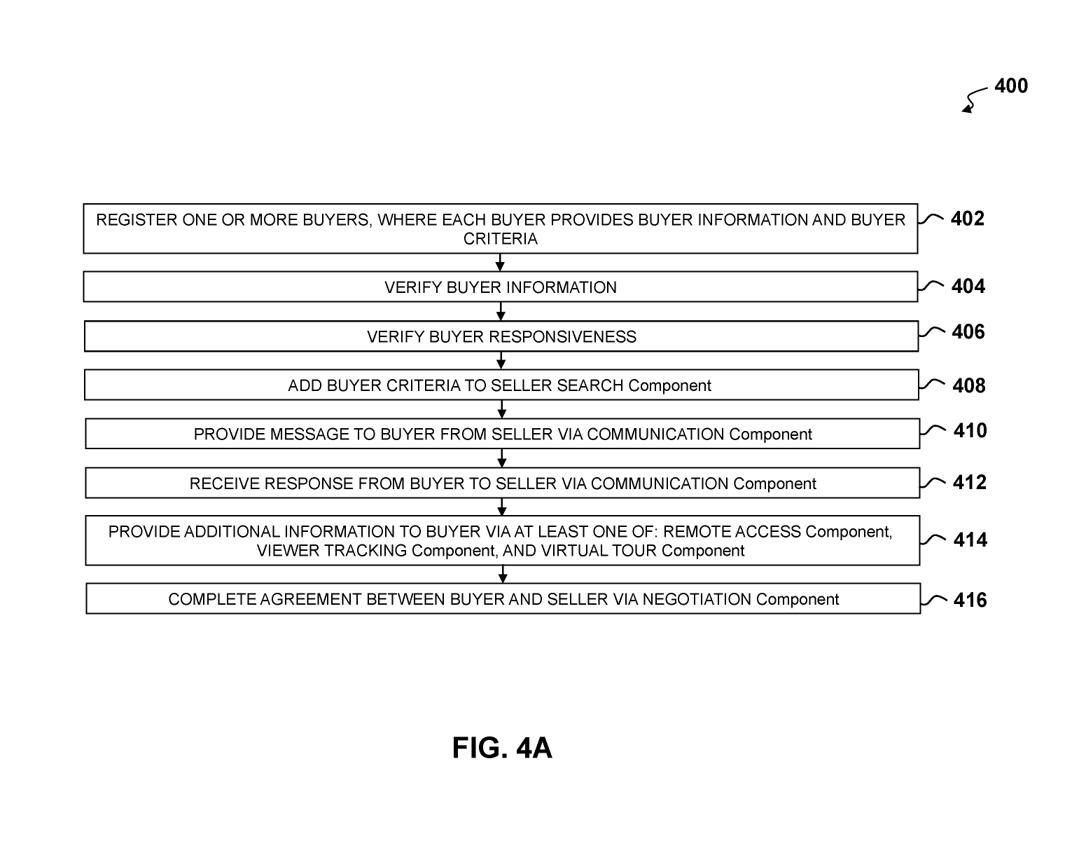

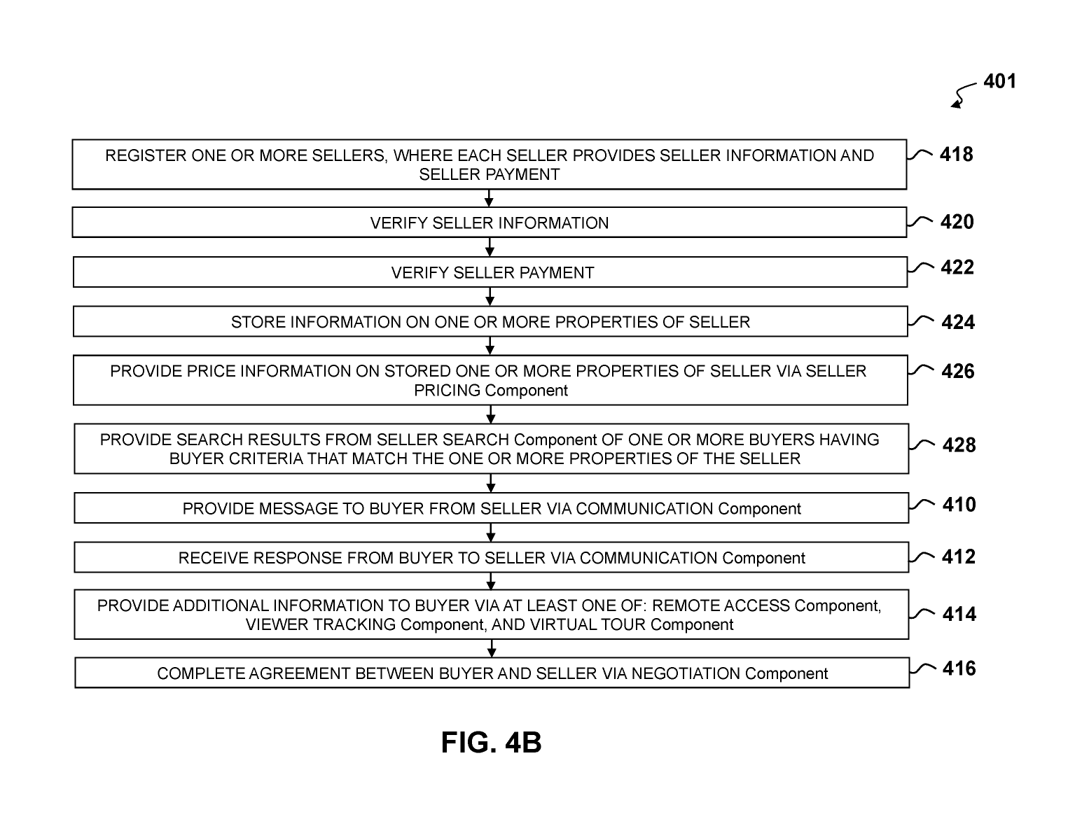

FIG. 4A depicts a high-level flowchart of a method embodiment 400 of completing a transfer or sale of real property by a buyer. One or more buyers may register with the system, where each buyer provides buyer information and buyer criteria (step 402). The system may then verify the buyer information (step 404) and verify the buyer responsiveness (step 406).

The system may then add the buyer criteria to the seller search component (step 408). When a seller identifies a buyer with criteria that matches one or more of their properties, the seller may send a message to the prospective buyers. The message from the seller may be provided to the buyer via the communication component (step 410).

The buyer may respond to the message from the seller via the communication component (step 412). Additional information may be provided to the buyer via the remote access component, viewer tracking component, and/or virtual tour component (step 414). An agreement between the buyer and seller may be facilitated via the negotiation component (step 416) based on using outside services offered by professionals in the industry. The negotiation component may receive a notification one the parties have entered into an agreement, thereby the property for the purchaser at a price they are comfortable with is secured, and the system gives the seller the confidence needed to move forward with their new residence.

FIG. 4B depicts a high-level flowchart of a method embodiment 401 of completing a transfer or sale of real property by a seller. One or more sellers may register with the system, where each seller provides seller information and seller payment (step 418). The system may then verify the seller information (step 420) and verify the seller payment (step 422).

The system may then store the information on the one or more properties of the seller (step 424). The system may also provide price information on the stored one or more properties of the seller via the seller pricing component (step 426). The seller may create one or more searches and the system may provide the search results to the seller (step 428).

When a seller identifies a buyer with criteria that matches one or more of their properties, the seller may send a message to the buyer. The message from the seller is provided to the buyer via the communication component (step 410), and may be transmitted directly to the buyer or through an intermediary computing device.

The buyer may respond to the communication from the seller via the communication component (step 412). Additional information may be provided to the buyer via the remote access component, viewer tracking component, and/or virtual tour component (step 414). An agreement between the buyer and seller may be completed via the negotiation component (step 416).

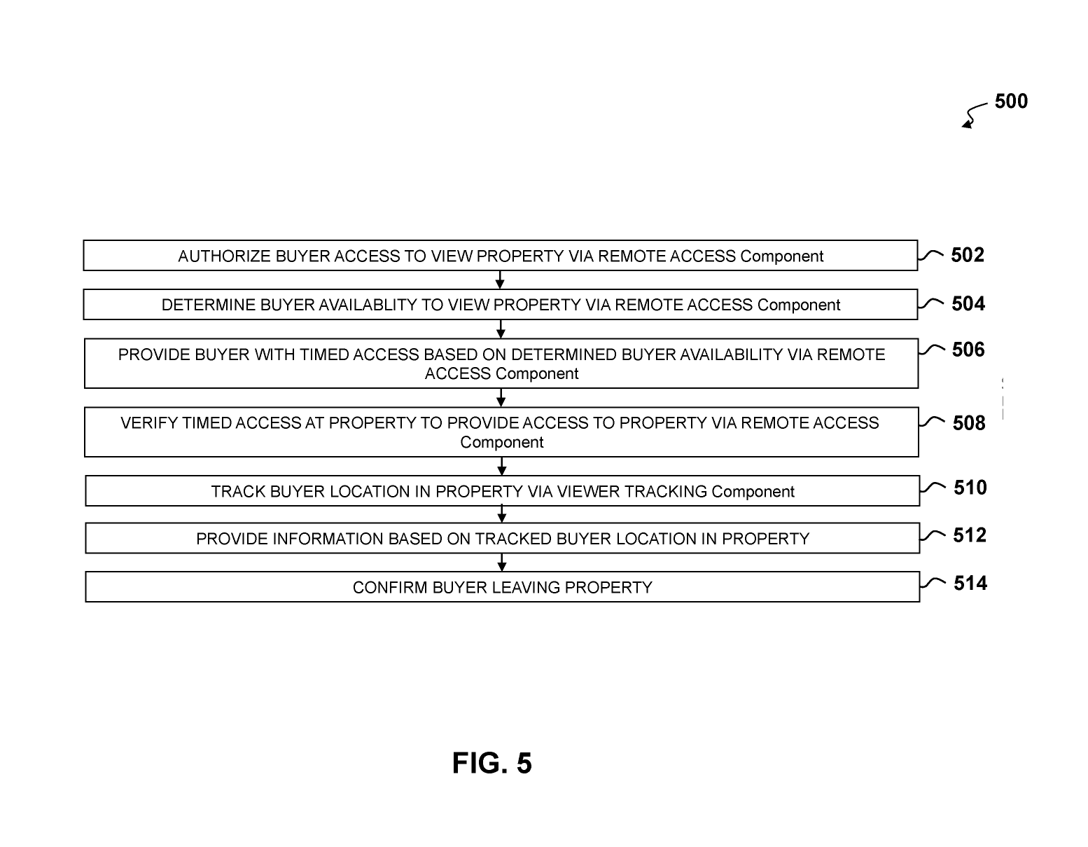

FIG. 5 depicts a high-level flowchart of a method embodiment 500 of providing access to real property. The system may authorize access to view a seller's property via the remote access component (step 502). The system may determine buyer availability to view the property via the remote access component (step 504). The system may provide the buyer with timed access to the property based on the determined buyer availability via the remote access component (step 508).

The system may track buyer location in the property via the viewer tracking component (step 510), for example, GPS. The system may provide information based on the tracked buyer location in the property (step 512). The system may confirm that the buyer has left the property (step 514), via the location information of the buyer device or other methods disclosed herein.

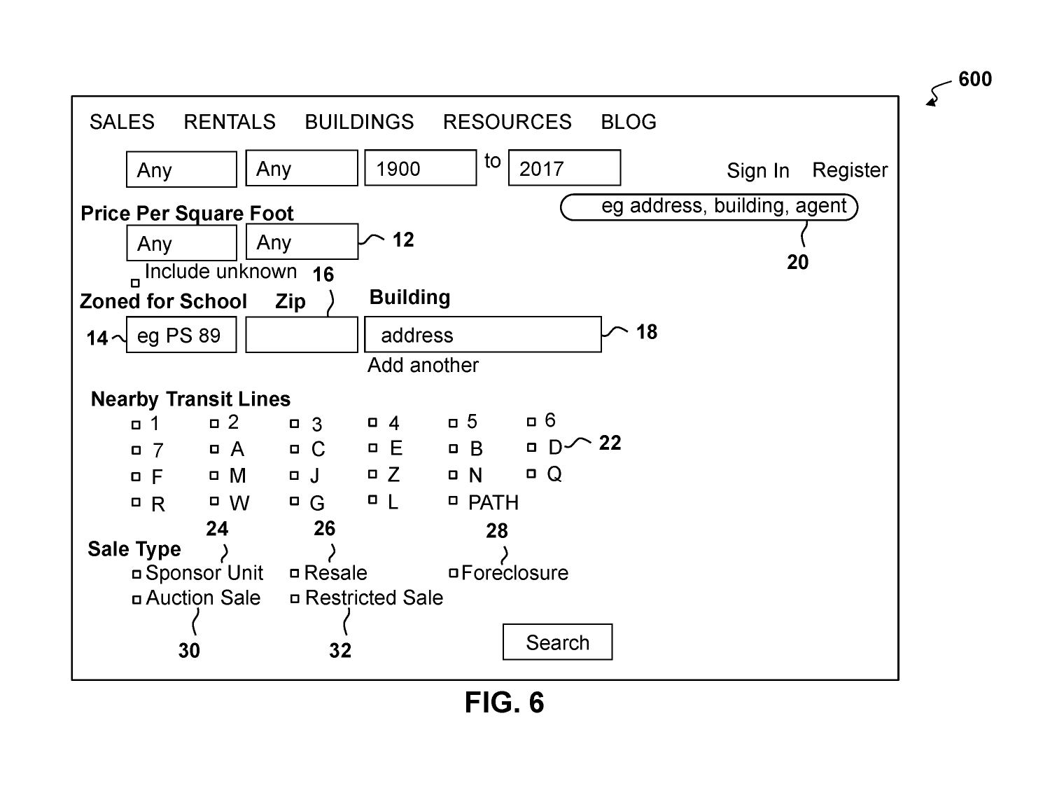

FIG. 6 depicts a search performed in the real property and asset information control system 600, according to one embodiment. The seller can input, for example, a range for the year built 8 of the building. They can also put in a specific address 20. The seller can input a range for the price per square foot 12, zone for school 14, zip code 16, building 18, nearby transit lines 22, sponsor unit 24, resale 26, foreclosure 28, auction sale 30, restricted sale 32. While some inputs are shown, other inputs may be added or removed as desired.

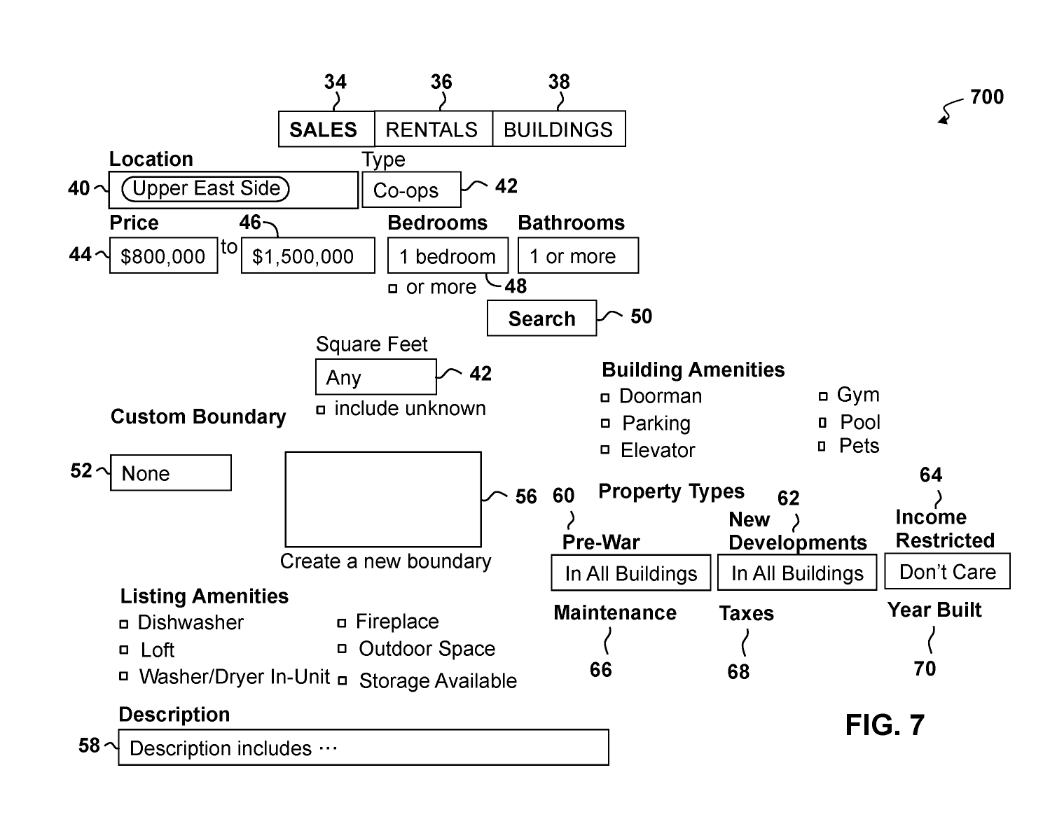

FIG. 7 depicts an alternate search performed in the real property and asset information control system 700, according to one embodiment. The seller can choose, for example, sales 34, rentals 36 and buildings 38, a neighborhood 40, type of building 42, price 44, 46, bedrooms 48 and a search 50 button. The user may also input square feet 54, create a custom boundary 52 on a map 56. The user may also select specific amenities they are looking for such as a dishwasher, fireplace, furnished, loft, public or private outdoor space, storage available, washer/dryer, doorman, elevator, fiber internet enabled, garage parking, gym, laundry in building, green building, parking available, pets allowed, pied a terre allowed, swimming pool, smoke fire, description 58 includes term, property type 60, new development 62, income restricted 64, maintenance 66, taxes 68 and year built 70. While some inputs are shown, other inputs may be added or removed as desired. The search terms are by way of example only, to provide a sample of ways in which owners of an asset may control disclosure of information to potential buyers/renters. By way of example, any of the above search terms may be made available or a subset of the search terms may be made available.

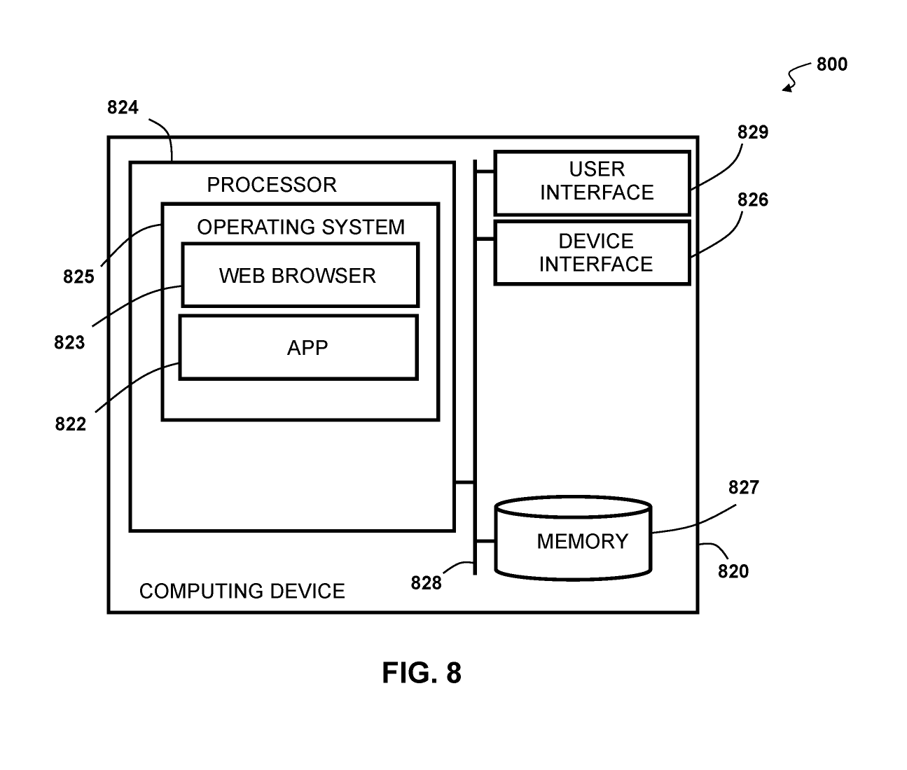

FIG. 8 illustrates an example of a top-level functional block diagram of a computing device embodiment 800. The example operating environment is shown as a computing device 820 comprising a processor 824, such as a central processing unit (CPU), addressable memory 827, an external device interface 826, e.g., an optional universal serial bus port and related processing, and/or an Ethernet port and related processing, and an optional user interface 829, e.g., an array of status lights and one or more toggle switches, and/or a display, and/or a keyboard and/or a pointer-mouse system and/or a touch screen. Optionally, the addressable memory may, for example, be: flash memory, eprom, and/or a disk drive or other hard drive. These elements may be in communication with one another via a data bus 828. In some embodiments, via an operating system 825 such as one supporting a web browser 823 and applications 822, the processor 824 may be configured to execute steps of a process establishing a communication channel and processing according to the embodiments described above.

System embodiments include computing devices such as a server computing device, a buyer computing device, and a seller computing device, each comprising a processor and addressable memory and in electronic communication with each other. The embodiments provide a server computing device that may be configured to: register one or more buyer computing devices and associate each buyer computing device with a buyer profile; register one or more seller computing devices and associate each seller computing device with a seller profile; determine search results of one or more registered buyer computing devices matching one or more buyer criteria via a seller search component. The service computing device may then transmit a message from the registered seller computing device to a registered buyer computing device from the determined search results and provide access to the registered buyer computing device of a property from the one or more properties of the registered seller via a remote access component based on the transmitted message and the associated buyer computing device; and track movement of the registered buyer computing device in the accessed property via a viewer tracking component. Accordingly, the system may facilitate the tracking of buyers by the system and sellers once they are on the property and aid in the seller's search for finding buyers for their property. The figures described below provide more details about the implementation of the devices and how they may interact with each other using the disclosed technology.

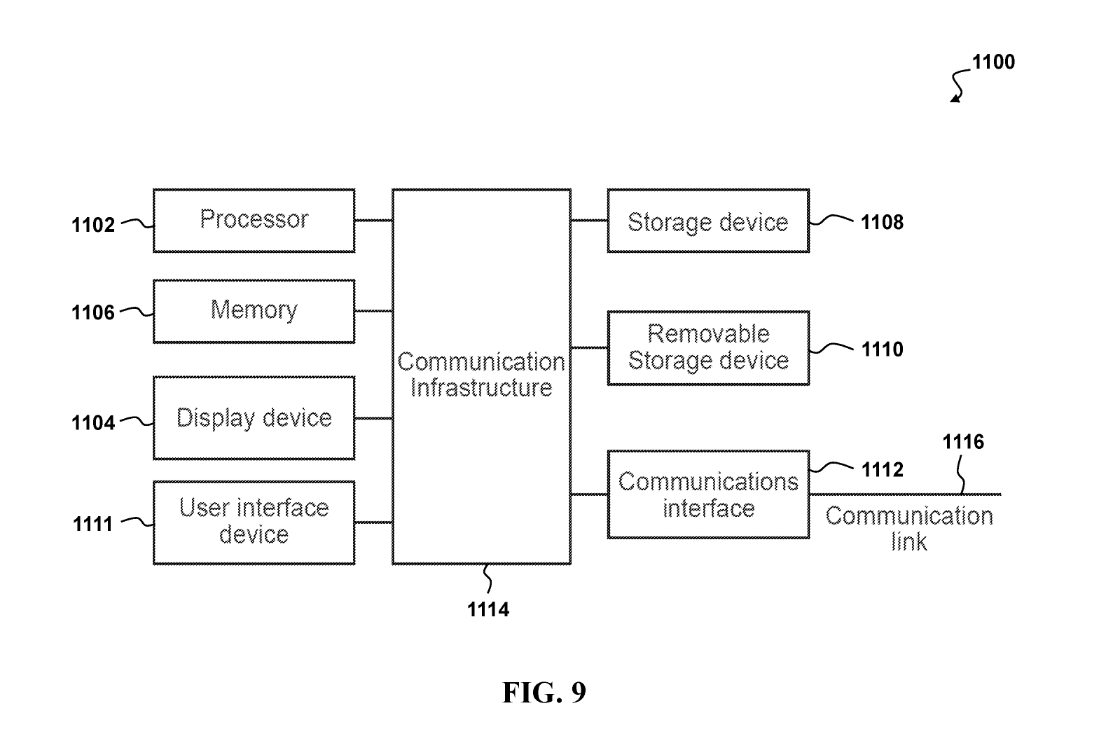

FIG. 9 is a high-level block diagram 1100 showing a computing system comprising a computer system useful for implementing an embodiment of the system and process, disclosed herein. Embodiments of the system may be implemented in different computing environments. The computer system includes one or more processors 1102, and can further include an electronic display device 1104 (e.g., for displaying graphics, text, and other data), a main memory 1106 (e.g., random access memory (RAM)), storage device 1108, a removable storage device 1110 (e.g., removable storage drive, a removable memory module, a magnetic tape drive, an optical disk drive, a computer readable medium having stored therein computer software and/or data), user interface device 1111 (e.g., keyboard, touch screen, keypad, pointing device), and a communication interface 1112 (e.g., modem, a network interface (such as an Ethernet card), a communications port, or a PCMCIA slot and card). The communication interface 1112 allows software and data to be transferred between the computer system and external devices. The system further includes a communications infrastructure 1114 (e.g., a communications bus, cross-over bar, or network) to which the aforementioned devices/modules are connected as shown.

Information transferred via communications interface 1114 may be in the form of signals such as electronic, electromagnetic, optical, or other signals capable of being received by communications interface 1114, via a communication link 1116 that carries signals and may be implemented using wire or cable, fiber optics, a phone line, a cellular/mobile phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 1112. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

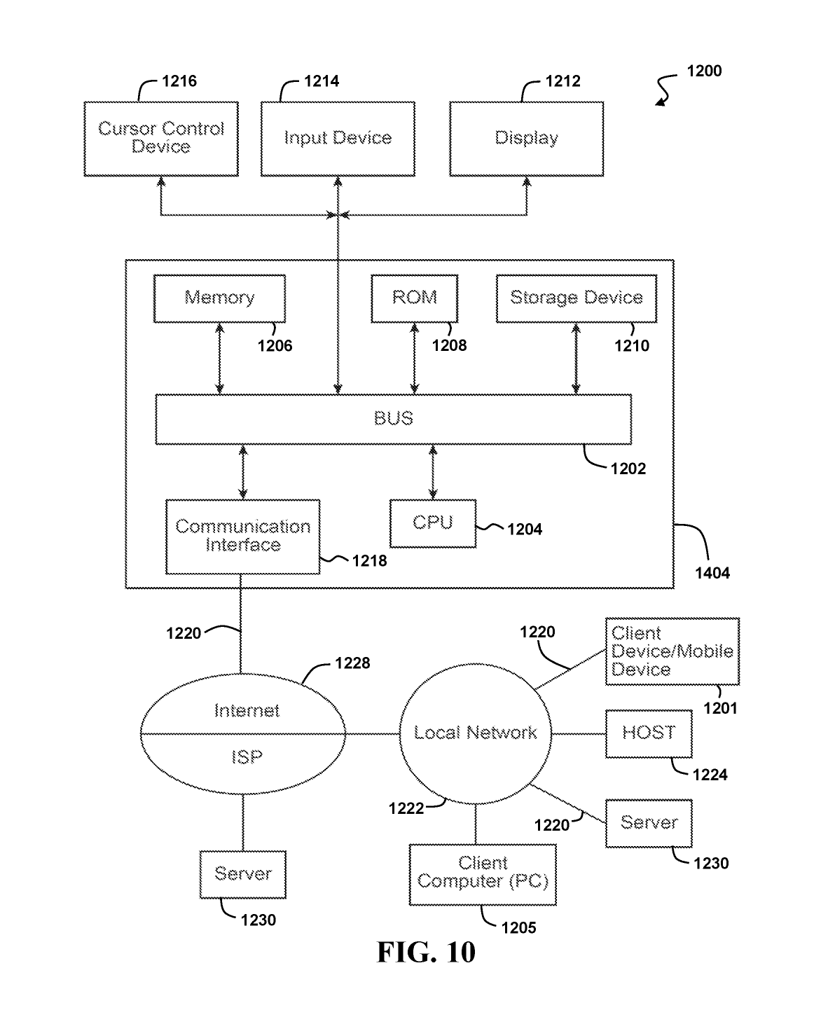

FIG. 10 shows a block diagram of an example system 1200 in which an embodiment may be implemented. The system 1200 includes one or more client devices 1201 such as consumer electronics devices, connected to one or more server computing systems 1230. A server 1230 includes a bus 1202 or other communication mechanism for communicating information, and a processor (CPU) 1204 coupled with the bus 1202 for processing information. The server 1230 also includes a main memory 1206, such as a random access memory (RAM) or other dynamic storage device, coupled to the bus 1202 for storing information and instructions to be executed by the processor 1204. The main memory 1206 also may be used for storing temporary variables or other intermediate information during execution or instructions to be executed by the processor 1204. The server computer system 1230 further includes a read only memory (ROM) 1208 or other static storage device coupled to the bus 1202 for storing static information and instructions for the processor 1204. A storage device 1210, such as a magnetic disk or optical disk, is provided and coupled to the bus 1202 for storing information and instructions. The bus 1202 may contain, for example, thirty-two address lines for addressing video memory or main memory 1206. The bus 1202 can also include, for example, a 32-bit data bus for transferring data between and among the components, such as the CPU 1204, the main memory 1206, video memory and the storage 1210. Alternatively, multiplex data/address lines may be used instead of separate data and address lines.

The server 1230 may be coupled via the bus 1202 to a display 1212 for displaying information to a computer user. An input device 1214, including alphanumeric and other keys, is coupled to the bus 1202 for communicating information and command selections to the processor 1204. Another type or user input device comprises cursor control 1216, such as a mouse, a trackball, or cursor direction keys for communicating direction information and command selections to the processor 1204 and for controlling cursor movement on the display 1212.

According to one embodiment, the functions are performed by the processor 1204 executing one or more sequences of one or more instructions contained in the main memory 1206. Such instructions may be read into the main memory 1206 from another computer-readable medium, such as the storage device 1210. Execution of the sequences of instructions contained in the main memory 1206 causes the processor 1204 to perform the process steps described herein. One or more processors in a multi-processing arrangement may also be employed to execute the sequences of instructions contained in the main memory 1206. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 1204 for execution. Such a medium may take many forms, including but not limited to, non-volatile media, volatile media, and transmission media. Non-volatile media includes, for example, optical or magnetic disks, such as the storage device 1210. Volatile media includes dynamic memory, such as the main memory 1206. Transmission media includes coaxial cables, copper wire and fiber optics, including the wires that comprise the bus 1202. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 1204 for execution. For example, the instructions may initially be carried on a magnetic disk of a remote computer. The remote computer can load the instructions into its dynamic memory and send the instructions over a telephone line using a modem. A modem local to the server 1230 can receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1206, from which the processor 1204 retrieves and executes the instructions. The instructions received from the main memory 1206 may optionally be stored on the storage device 1210 either before or after execution by the processor 1204.

The server 1230 also includes a communication interface 1218 coupled to the bus 1202. The communication interface 1218 provides a two-way data communication coupling to a network link 1220 that is connected to the world wide packet data communication network now commonly referred to as the Internet 1228. The Internet 1228 uses electrical, electromagnetic or optical signals that carry digital data streams. The signals through the various networks and the signals on the network link 1220 and through the communication interface 1218, which carry the digital data to and from the server 1230, are exemplary forms or carrier waves transporting the information.

In another embodiment of the server 1230, interface 1218 is connected to a network 1222 via a communication link 1220. For example, the communication interface 1218 may be an integrated services digital network (ISDN) card or a modem to provide a data communication connection to a corresponding type of telephone line, which can comprise part of the network link 1220. As another example, the communication interface 1218 may be a local area network (LAN) card to provide a data communication connection to a compatible LAN. Wireless links may also be implemented. In any such implementation, the communication interface 1218 sends and receives electrical electromagnetic or optical signals that carry digital data streams representing various types of information.

The network link 1220 typically provides data communication through one or more networks to other data devices. For example, the network link 1220 may provide a connection through the local network 1222 to a host computer 1224 or to data equipment operated by an Internet Service Provider (ISP). The ISP in turn provides data communication services through the Internet 1228. The local network 1222 and the Internet 1228 both use electrical, electromagnetic or optical signals that carry digital data streams. The signals through the various networks and the signals on the network link 1220 and through the communication interface 1218, which carry the digital data to and from the server 1230, are exemplary forms or carrier waves transporting the information.

The server 1230 can send/receive messages and data, including e-mail, program code, through the network, the network link 1220 and the communication interface 1218. Further, the communication interface 1218 can comprise a USB/Tuner and the network link 1220 may be an antenna or cable for connecting the server 1230 to a cable provider, satellite provider or other terrestrial transmission system for receiving messages, data and program code from another source.

The example versions of the embodiments described herein may be implemented as logical operations in a distributed processing system such as the system 1200 including the servers 1230. The logical operations of the embodiments may be implemented as a sequence of steps executing in the server 1230, and as interconnected machine modules within the system 1200. The implementation is a matter of choice and can depend on performance of the system 1200 implementing the embodiments. As such, the logical operations constituting said example versions of the embodiments are referred to for e.g., as operations, steps or modules.

Similar to a server 1230 described above, a client device 1201 can include a processor, memory, storage device, display, input device and communication interface (e.g., e-mail interface) for connecting the client device to the Internet 1228, the ISP, or LAN 1222, for communication with the servers 1230.

The system 1200 can further include computers (e.g., personal computers, computing nodes) 1205 operating in the same manner as client devices 1201, where a user can utilize one or more computers 1205 to manage data in the server 1230.

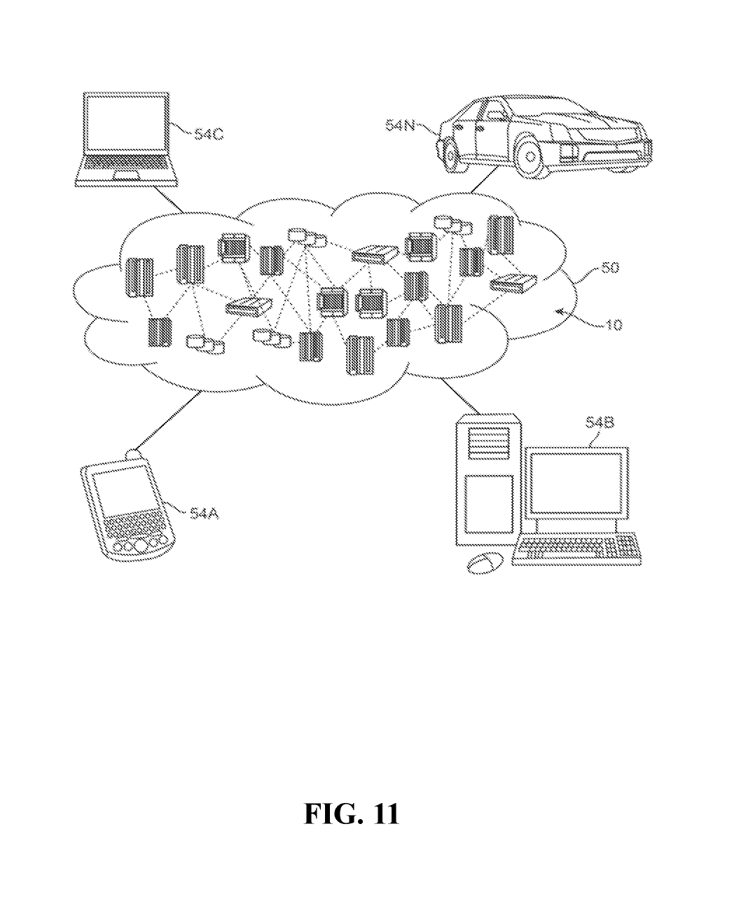

Referring now to FIG. 11, illustrative cloud computing environment 50 is depicted. As shown, cloud computing environment 50 comprises one or more cloud computing nodes 10 with which local computing devices used by cloud consumers, such as, for example, personal digital assistant (PDA), smartphone, smart watch, set-top box, video game system, tablet, mobile computing device, or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 13 are intended to be illustrative only and that computing nodes 10 and cloud computing environment 50 can communicate with any type of computerized device over any type of network and/or network addressable connection (e.g., using a web browser).

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention is herein disclosed by way of examples and should not be limited by the particular disclosed embodiments described above.

What is claimed is:

1. A system comprising:
a server computing device, a buyer computing device, and a seller computing device, each comprising a processor and addressable memory and in electronic communication with each other;
wherein the server computing device is configured to:
register one or more buyer computing devices and associate each buyer computing device with a buyer profile;
register one or more seller computing devices and associate each seller computing device with a seller profile;
determine search results of one or more registered buyer computing devices matching one or more buyer criteria via a seller search component;
transmit a message from the registered seller computing device to a registered buyer computing device from the determined search results;
provide access to the registered buyer computing device of a property from the one or more properties of the registered seller via a remote access component based on the transmitted message and the associated buyer computing device; and
track movement of the registered buyer computing device in the accessed property via a viewer tracking component.

2. The system of claim 1 further comprising a remote lock having a processor and addressable memory, the remote lock in communication with a remote access component of the server computing device and the registered buyer computing device in communication with the remote access component;
wherein the remote access component is configured to send a code to the remote lock and the registered buyer computing device.

3. The system of claim 2, wherein the first buyer computing device is configured to transmit the code.

4. The system of claim 3, wherein the remote lock is configured to receive the code transmitted by the registered buyer device.

5. The system of claim 4, wherein the remote lock is configured to unlock a door if the received code transmitted by the registered buyer computing device matches the code received by the remote access component.

6. The system of claim 1, wherein the tracking movement is via signals transmitted from the registered buyer computing device to the server computing device.

7. The system of claim 1, wherein the server computing device is configured to facilitate an agreement between the registered buyer and the registered seller for the property of the registered seller via a negotiation component.

8. The system of claim 1, wherein the seller computing device is configured to determine whether grant access to the buyer computing device based on information received from the server computing device, the information comprising location of the buyer computing device.

9. A method comprising:
registering one or more buyers and associated buyer computing device with a server computing device, wherein each buyer registration comprises buyer information and buyer criteria;
registering one or more sellers and associated seller computing device with the server computing device, wherein each seller registration comprises seller information and one or more properties;
determining, by the server computing device, search results of one or more registered buyers matching one or more buyer criteria via a seller search component;
transmitting a message from a registered seller computing device to a registered buyer computing device from the determined search results;
providing access to the registered buyer of a property from the one or more properties of the registered seller via a remote access component based on the transmitted message and the associated buyer computing device;
tracking movement of the registered buyer in the accessed property via a viewer tracking component, wherein the tracking movement is via signals transmitted from the registered buyer computing device to the server computing device; and
facilitating an agreement between the registered buyer and the registered seller for the property of the registered seller via a negotiation component.
